(19) United States
(12) Patent Application Publication
(10) Pub. No.: US 2007/0136510 A1
(43) Pub. Date: Jun. 14, 2007

(54) Storage device, memory managing device, memory managing method, and program

(76) Inventor: Hiroshi Ippongi, Miyagi (JP)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/595,759

(22) Filed: Nov. 9, 2006

(30) Foreign Application Priority Data
Nov. 9, 2005 (JP) 2005-324585

(51) Int. Cl. G06F 12/00

(52) U.S. Cl. 711/103

(57) ABSTRACT

A controller stores a BSI (Block Search Index) to specify an empty block of a lash memory. The controller determines whether a pointer indicating a physical block address of an empty block is stored. If no such pointer is stored, the controller generates a random number based on the BSI, determines the initial value of the pointer based on the generated random number, and stores a pointer indicating this initial value. When supplied with user data, which is the objective of writing, the controller writes the user data in the empty block indicated by the pointer. The controller updates the pointer to indicate an empty block having a physical block address which appears next to the address of that block, and updates the BSI such that it no longer indicates that the block in which the user data has been written is an empty block.

### BACKGROUND OF THE INVENTION

1. Field of the Invention

The present invention relates to a data processing system utilizing a recording medium, and a computer-readable program for accessing a recording medium.

2. Description of the Related Art

A flash memory is used as a recording medium accessible (i.e., data readable and writable) by a computer. Erasing data from a flash memory is performed by a predetermined storage capacity (generally called “block”).

The following operations are performed when rewriting the data stored in such a flash memory. First, an empty block is detected. In the same block where the to-be-erased data is stored, there are other data available. These other data is transferred out to the detected empty block. The new (to-be-written) data are also written to the detected empty block. Then, the original block with the to-be-erased data is flash-erased, that is, the contents stored in the original block are erased. Therefore when a flash memory is used, empty blocks from flash-erasing are created and reused quite frequently.

Flash-erasing of blocks is performed many times. This will result in the deterioration of the blocks, i.e., it change the blocks into defective ones in which data cannot be stored properly. It is desirable that the same block not be flash-erased more than necessary.

From this viewpoint, it is not appropriate to employ a searching method in which the blocks are searched in the order of their physical block-addresses to locate an empty block each time there is new data to be written. In this method, the blocks with physical block addresses being close to the head (first) address are intensively flash-erased and data-written. Consequently, such blocks will be intensively degenerated.

Hence, as disclosed in, for example, Unexamined Japanese Patent Application KOKAI Publication No. 2003-50747, a method where a certain CPU (Central Processing Unit) generates random numbers and determines the empty blocks to write data based on these random numbers, has been devised. With this method, intensive deterioration of certain blocks can be avoided.

However, generation of random numbers by a CPU has actually been embodied in the form of generation of pseudo random numbers based on the use of certain data as a seed. Therefore, the generated sequence of random numbers will have a certain pattern. Thus, the blocks with the physical block addresses coinciding with this pattern will be intensively flash-erased and data-written. In this case, the problem that these blocks will be intensively deteriorated will still arise.

The present invention was made in view of the above-described circumstance, and an objective of the present invention is to provide a storage device, a memory managing device, a memory managing method, and a program which can prevent intensive deterioration of specific blocks.

### SUMMARY OF THE INVENTION

To achieve the above object, a storage device according to a first aspect of the present invention comprises:

a storage unit including a plurality of memory blocks, each of which has an assigned physical addresses, and which are for storing user data;

a pointer storage unit which stores a pointer indicating the physical address of one empty block in said memory blocks that are ready to store a user data;

a pointer initial value generating unit which generates an initial value of the pointer;

a writing unit which writes to-be-written user data in said empty block indicated by the pointer; and

a pointer updating unit which updates the pointer to indicate another empty block having a physical address next to the physical address of said empty block indicated by the pointer, in the case where said empty block indicated by the pointer is designated as a destination of the to-be-written data;

wherein said pointer initial value generating unit generates a random number based on predetermined data which will be changed each time user data is newly stored in any empty block, determines an initial value, based on the random number, of an address of empty blocks in which user data is to be written, and stores the pointer indicating this initial value in said pointer storage unit.

According to this storage device, an empty block in which data is to be written is searched sequentially starting from the physical address that the pointer indicates. Meanwhile, the initial value of the pointer is determined based on a random number generated based on predetermined data which will be changed each time user data is written in any empty block. Consequently, the generated random number sequence will not have a certain pattern. Accordingly, it prevents an problem in the prior art that certain physical addresses that coincide with the pattern of the generated random number sequence will intensively be flash-erased and data-written and thus intensively deteriorated.

The storage device may further comprise

an empty block table storage unit which stores an empty block table for storing information to specify an empty block, among said memory blocks, that is in a user data storable state,

wherein said pointer initial value generating unit generates a random number based on a content of said empty block table, and determines an initial value of empty blocks in which user data is to be written based on the generated random number.

According to this storage device, an empty block in which data is to be written is searched sequentially started from the physical address that the pointer indicates. Meanwhile, the initial value of the pointer is determined based on a random number generated based on the empty block table. Since the empty block table is changed every time an empty block is newly used or a block is flash-erased, the generated random number sequence will not have a certain pattern. Accordingly, a situation is prevented that blocks having the physical addresses that coincide with a certain pattern of the random numbers will be intensively flash-erased and data-written and thus intensively deteriorated.

The pointer initial value generating unit may comprise:

a logical calculation unit which generates calculated data representing an exclusive OR of a portion of data stored in said empty block table, that occupies a predetermined position of said empty block table and has a predetermined length, and a portion of the stored data that succeeds said portion and has the predetermined length, and after this repeats a process of generating calculated data representing an exclusive OR of calculated data generated most recently and a portion of the stored data that has the predetermined length and appears next to data portions stored in said empty block table that have not yet been used for generating calculated data, until all portions of said empty block table have been used for generating calculated data;

a random number generating unit which generates random number data representing a natural pseudo random number, whose maximum value is a total number of empty blocks currently registered in said empty block table, and the random number data being generated by using calculated data generated last by said logical calculation unit as a seed; and

an initial value determining unit which determines a physical address, among the physical addresses of empty blocks currently registered in said empty block table, whose order is equal to a value of the random number data, as the initial value, and stores the pointer which indicates this initial value.

A memory managing device according to a second aspect of the present invention is a memory managing device which stores user data in a memory including a plurality of memory blocks which are assigned physical addresses and which are for storing user data, the memory managing device comprising:

a pointer storage unit which stores a pointer indicating the physical address of one empty block, among said memory blocks, that is in a user data storable state;

a pointer initial value generating unit which generates an initial value of the pointer;

a writing unit which writes user data, which is an objective of writing, in said empty block indicated by the pointer; and

a pointer updating unit which updates the pointer to indicate another empty block having a physical address that appears next to the physical address of said empty block indicated by the pointer, in the case where said empty block indicated by the pointer is designated as a destination at which the user data as the objective of writing is to be written,

wherein said pointer initial value generating unit generates a random number based on predetermined data which will be changed each time user data is newly stored in any empty block, determines an initial value of empty blocks in which user data is to be written based on the generated random number, and stores the pointer indicating this initial value in said pointer storage unit.

The memory managing device may further comprise

an empty block table storage unit which stores an empty block table for storing information to specify an empty block, among said memory blocks, that is in a user data storable state,

wherein said pointer initial value generating unit generates a random number based on a content of said empty block table, and determines an initial value of empty blocks in which user data is to be written based on the generated random number.

The pointer initial value generating unit may comprise:

a logical calculation unit which generates calculated data representing an exclusive OR of a portion of data stored in said empty block table, that occupies a predetermined position of said empty block table and has a predetermined length, and a portion of the stored data that succeeds said portion and has the predetermined length, and after this repeats a process of generating calculated data representing an exclusive OR of calculation data generated most recently and a portion of the stored data that has the predetermined length and appears next to data portions stored in said empty block table that have not yet been used for generating calculation data, until all portions of said empty block table have been used for generating calculated data;

a random number generating unit which generates random number data representing a natural pseudo random number, whose maximum value is a total number of empty blocks currently registered in said empty block table, by using calculated data generated last by said logical calculation unit as a seed; and

an initial value determining unit which determines a physical address, among the physical addresses of empty blocks currently registered in said empty block table, whose order is equal to a value of the random number data, as the initial value, and stores the pointer indicating this initial value.

A memory managing method according to a third aspect of the present invention is a memory managing method for storing user data in a memory including a plurality of memory blocks which are assigned physical addresses and for storing user data, the method comprising:

a pointer initial value generating step of generating an initial value of the pointer, in a case where it is determined that the pointer storage unit does not store the pointer;

a step of determining an empty block indicated by the pointer, as a destination at which user data, which is an objective of writing, is to be written; and

a pointer updating step of updating the pointer to indicate another empty block having a physical address that appears next to the physical address of said empty block indicated by the pointer, when said empty block indicated by the pointer is designated as a destination at which the user data as the objective of writing is to be written,

wherein at said pointer initial value generating step, a random number is generated based on based on predetermined data which will be changed each time user data is newly stored in any empty block, an initial value of empty blocks in which user data is to be written is determined based on the generated random number, and the pointer, which indicates this initial value, is stored in said pointer storage unit.

The memory managing method may further comprise

a determining step of determining whether or not a pointer storage unit stores the pointer indicating the physical address of one empty block, among the memory blocks, that is in a user data storable state, in the case where to-be-written user data is specified.

A recording medium according to a fourth aspect of the present invention stores a program for controlling a computer to function as a memory managing device for storing user data in a memory including a plurality of memory blocks which are assigned physical addresses and for storing user data, the memory managing device comprising:

a pointer storage unit which stores a pointer, which indicates the physical address of one empty block, among said memory blocks, that is in a user data storable state;

a pointer initial value generating unit which generates an initial value of the pointer;

a writing unit which writes user data, which is an objective of writing, in said empty block indicated by the pointer; and

a pointer updating unit which updates the pointer to indicate another empty block having a physical address that appears next to the physical address of said empty block indicated by the pointer, when said empty block indicated by the pointer is designated as a destination at which the user data as the objective of writing is to be written,

wherein said pointer initial value generating unit generates a random number based on predetermined data which will be changed each time user data is newly stored in any empty block, determines an initial value of empty blocks in which user data is to be written based on the generated random number, and stores the pointer, which indicates this initial value, in said pointer storage unit.

According to the present invention, a storage device, a memory managing device, a memory managing method, and a program, which can prevent intensive deterioration of specific blocks, can be realized.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the structure of a storage system according to an embodiment of the present invention;

FIG. 2 is a diagram exemplarily showing the logical structure of the storage area of a flash memory;

FIG. 3 is a diagram exemplarily showing the data structure of a BPT (Block Pointer Table);

FIG. 4 is a diagram exemplarily showing the data structure of a BSI (Block Search Index);

FIG. 5 is a flowchart showing the procedures of an initial process;

FIG. 6 is a flowchart showing a data writing process;

FIG. 7 is a flowchart showing an old user data reading process;

FIG. 8 is a flowchart showing a BPT updating process;

FIG. 9 is a flowchart showing a process for designating an empty block in which user data is to be written;

FIG. 10 is a continuation of the flowchart showing the BPT updating process;

FIG. 11 is a flowchart showing a new user data writing process;

FIG. 12 is a continuation of the new user data writing process;

FIG. 13 is a flowchart showing an old user data erasing process; and

FIG. 14 is a flowchart showing an old BPT erasing process.

### DETAILED DESCRIPTION OF THE PREFERRED EMBODIMENT

An embodiment of the present invention will be described below with reference to the drawings, by employing a storage system having a flash memory as an example.

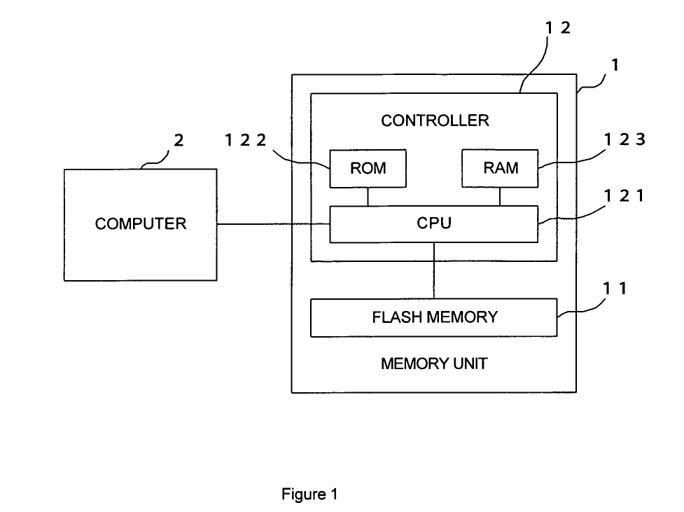

FIG. 1 is a block diagram showing the physical structure of a storage system according to an embodiment of the present invention. As shown in FIG. 1, the storage system comprises a memory unit 1 and a computer 2.

The memory unit 1 is connected to the computer 2. The memory unit 1 and the computer 2 may be connected fixedly. Alternatively, for example, assuming that the computer 2 has a slot for relaying a bus which complies with the PC Card Standard, the memory unit 1 may be detachably connected to the computer 2 through this slot.

The memory unit 1 comprises a flash memory 11 and a controller 12.

The flash memory 11 responds to the accesses from the controller 12. The flash memory 11 stores data supplied by the controller 12, supplies stored data in itself to the controller 12, and erases data stored therein.

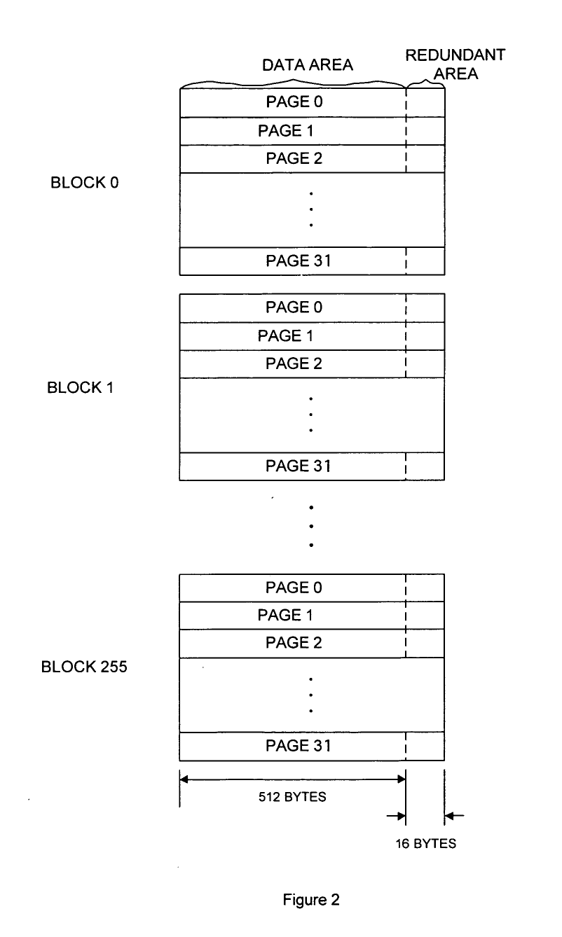

The storage area in the flash memory 11 comprises, for example, 256 blocks, as shown in FIG. 2. The respective blocks are assigned physical blocks of 0 to 255 successively from the top block. Each block comprises 32 pages, pages 0 through 31.

Each page comprises 528 memory cells each having 1 byte, having totally 528 bytes. The memory cells in each page are assigned addresses of 0 to 527 successively from the top cell. The entire storage area of the flash memory 11 comprises 8,192 pages.

Each page comprises a data area with 512 bytes at the beginning and a redundant area with 16 bytes at the end.

The data area stores user data. User data is either supplied from/to the computer 2. The redundant area stores data such as an error correction code to confirm that the content of the user data is not destroyed. In a case where a block postnatally becomes unable to properly read or record data, a defective block flag will be stored in the redundant area. The defective block flag is such that it indicates the block being postnatal defective according to a later-described process of the controller 12.

Further, the value of a logical block address assigned to each block is stored in the redundant area of each page belonging to that block.

The logical block address is a unit recognized by the controller 12 when reading or writing data to/from the flash memory 11 according to a later-described operation. The total number of blocks (logical blocks) which has logical block addresses assigned is a predetermined number smaller than the total number of blocks physically included in the flash memory 11, for example, 250 blocks.

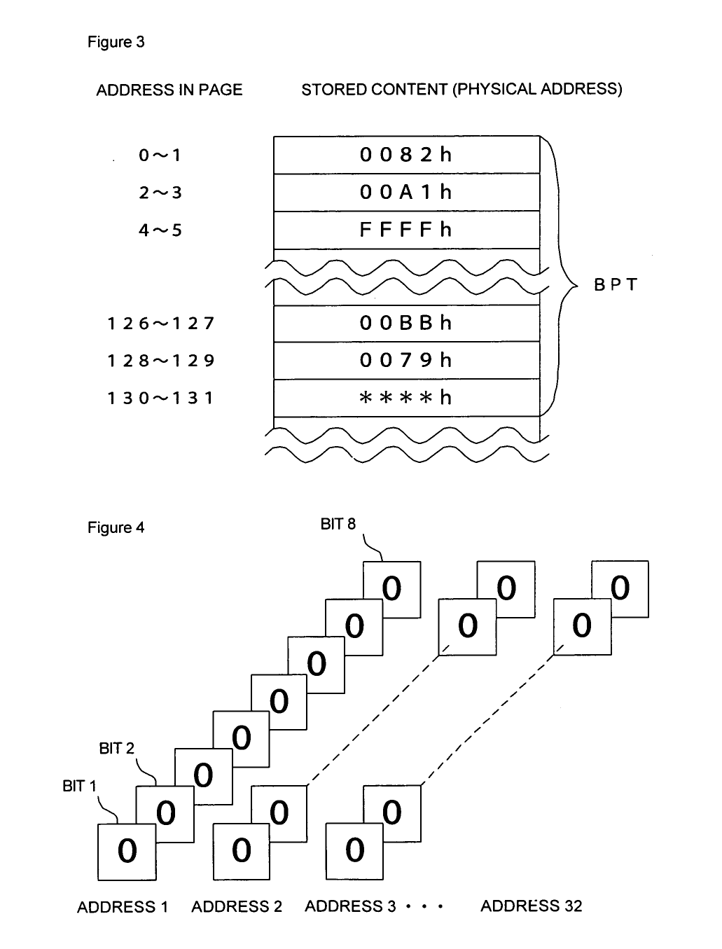

The data area is also used to store a BPT (Block Pointer Table). The BPT is data to be stored according to a later-described process performed by the controller 12. For example, the BPT comprises a table which stores the logical block address and the physical block address in association with each other for each block of the flash memory 11, as shown in FIG. 3. An error-correction code confirming that the content of the BPT is not destroyed are stored in the redundant area of the page where the BPT is stored.

The controller 12 performs a process described later every time the content of the BPT becomes inconsistent with the actual correspondence between the logical block address and physical block address of any block. When that happens, a new BPT showing the correct correspondence is generated and stored in the data area of the flash memory 11.

No user data is stored in the block which includes the page where the BPT is stored. The range of the logical block addresses that comprise pages in which the BPT is stored does not overlap with the range of the logical block addresses that comprise pages in which user data is stored.

One BPT has a storage capacity equal to or smaller than that of the data area of one page of the flash memory 11, i.e., one BPT is stored in the data area of one page. A logical block address having a value (for example, “100h”), which is larger than the total number of the logical blocks in the flash memory 11, is stored in the redundant area of that page. In the present specification and drawings, the numbers having a character “h” at the end represent hexadecimal numbers.

At first, the controller 12 stores a BPT in the top page of an empty block (i.e., a block without any page storing data). Thereafter, the controller 12 stores the BPT in the succeeding page in the same block every time a new BPT is generated. That is, the controller 12 stores the BPT in the top page among the pages in which no BPT has been stored.

The BPT has multiple storage areas associated with the logical block addresses with serial addresses. The physical block address associated with that logical block address is stored in one storage area associated with one logical block address.

Specifically, for example, it is assumed that storage areas of totally 2 bytes whose addresses are (2·n) and {(2·n)+1} (where n is an integer equal to or larger than 0 and equal to or smaller than 255) are associated with a logical block address n, as shown in FIG. 3. It is further assumed that a value “005Ah” is stored in the storage area whose address is 1. In this case, a block with the physical block address of 005Ah is associated with a logical block address of 0001h.

It should be noted that when a specific predetermined value (for example, a value “FFFFh” as shown in FIG. 3) is stored in this area, no physical block address is associated with the logical block address.

When the flash memory 11 is instructed by the controller 12 of the memory unit 1 to erase data in a specific block, the flash memory 11 resets the stored contents in all the memory cells in that block. For example, in a case where the flash memory 11 is of a NAND type, it stores a value “1” in all the memory cells in the block.

The flash memory 11 comprises an internal register and a sequencer. When the CPU (described later) instructs the flash memory 11 to write data, the sequencer of the flash memory 11, following this instruction, writes data while it verifies the written data at the same time. It sets the result of the verification (whether the writing was performed normally or not) in the internal register.

As shown in FIG. 1, the controller 12 comprises a CPU (Central Processing Unit) 121, a ROM (Read Only Memory) 122, and a RAM (Random Access Memory) 123.

The CPU 121 is connected to the ROM 122, the RAM 123, and the flash memory 11. The CPU 121 is also connected to the computer 2. The connection between the CPU 121 and the computer 2 may be a fixed one. Or, it may be a detachable through the above-described slot of the computer 2.

The CPU 121 performs the processes to be described later, such as writing data onto the flash memory 11, reading data from the flash memory 11, erasing (flash erasing) data stored in the flash memory 11, and so on. These are performed according to the processes of a program stored beforehand in the ROM 122 by the manufacturer (or the like) of the controller 12.

When a command from the computer 2 as the accessing device is received, the CPU 121 executes the command. Commands executed by the CPU 121 include a command for accessing the flash memory 11.

The RAM 123 is constituted by, for example, an SRAM (Static RAM) or the like. The RAM 123 provides a storage area and a saving memory area. The storage area provides for the work area of the CPU 121. The saving memory area is a temporal storage area for storing (saving) the data including the ones in the page to which data is to be written in a later-described data writing process. The data for temporal storage includes, for example, user data or a BPT.

The RAM 123 stores a BSI (Block Search Index) generated by the CPU 121. The BSI stores information to specify the empty block of the flash memory. The BSI is generated and updated by the controller 12 and stored in the RAM 123.

The BSI stores information representing which of the blocks of the flash memory 11 is an empty block (i.e., a block in the reset state). The BSI is generated according to a later-described process of the controller 12 each time the present storage system is activated, and stored in the RAM 123.

One example of the structure of the BSI in a case where the total number of the blocks of the flash memory 11 is 256 is shown in FIG. 4. As shown in FIG. 4, the BSI is made of 32-byte data. The bits are in one-to-one correspondence with the blocks 0 to 255 from the top bit downward, and each bit stores “1” when its corresponding block is an empty block. Each bit stores “0” when the corresponding block is not an empty block.

The RAM 123 also stores an initial empty-block-search pointer, according to a process performed by the CPU 121. The initial empty-block-search pointer is a pointer whose value is the physical block address of the empty block which the CPU 121 sees as the next objective of data writing. The initial empty-block-search pointer is updated according to a later-described process by the CPU 121.

The computer 2, which is constituted by a personal computer or the like, stores program data representing the OS and driver, and executes the OS after the power is on. Then, the computer 2 activates the driver according to the process of the OS.

The computer 2, which executes the processes of the driver, supplies the above-described commands and/or the data which is to be written in the flash memory 11 to the controller 12, thereby causing the CPU 121 to access the flash memory 11. And the computer 2 receives data from the CPU 121, where the data is provided from the flash memory 11 according to the commands given by the computer 2.

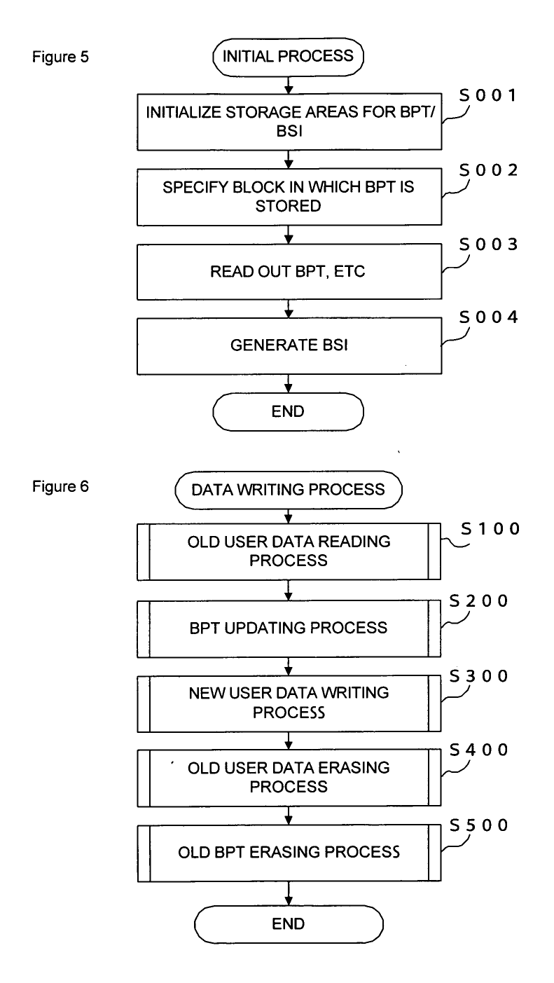

Next, the operation of the storage system will be explained with reference to FIG. 5 to FIG. 14.

When the present storage system is activated, the CPU 121 of the controller 12 of the memory unit 1 performs the initial process shown in FIG. 5. When the initial process is started, the CPU 121 initializes the portions of the storage area of the RAM 123 in which the BPT and the BSI are to be stored (FIG. 5, step S001). For example, the CPU 121 may change the logical values of all the bits of the RAM 123 to “0” in the storage area where the BPT or the BSI is to be stored.

Next, the CPU 121 specifies the block in which the BPT is stored, by, for example, searching and checking the logical block address in the redundant area of the top page of each block (step S002).

Next, the CPU 121 reads out the BPT from the data area of the page in the block specified at step S002. Further, the CPU 121 reads out the error-correction code from the redundant area of the specified page, and stores it in the storage area of the RAM 123 (step S003).

Next, the CPU 121 corrects any correctable error included in the BPT stored in the RAM 123 by using the error correction code that was read out at step S003 according to a known method, and goes to step S004.

At step S004, the CPU 121 generates a BSI. Specifically, the CPU 121 reads out the data stored in the redundant area of the page of each block of the flash memory. 11 sequentially (for example, block by block sequentially from the block having the top physical block address to the end). Meanwhile, every time that data is read out from one block, the CPU 121 determines whether or not the block from which the data is read out is an empty block, based on the data read out. For example, the CPU 121 may determine whether an empty-block code in predetermined format is stored in the data read out. Then, the CPU 121 adds he result to the BSI in the RAM 123. For example, the CPU 121 changes the value of the bit in the BSI that corresponds to the concerned block to “1” when hat block is an empty block, and leaves the bit having “0” in a case where the block is not an empty block.

The storage system terminates its initial process when the BSI is generated.

Through the initial process explained above, the BPT is copied into the storage area of the RAM 123 and updated to represent the correct content, and he BSI is generated.

When the initial process is completed, the CPU 121 receives a command to access to the flash memory 11 from the computer 2. Then, the computer 2 supplies a command to the controller 12 instructing to read the user data along with the logical block address and page address from which page the data is to be read out. The CPU 121 of the controller 12 searches the BPT using the supplied logical block address as the key. The physical block address associated with this logical block address is found. The CPU 121 reads out data from the page specified by the found physical block address and the page address from the computer 2, and it supplies the data to the computer 2. As a result, data is read out from the flash memory 11 and supplied to the computer 2.

In a case where the storage area of the flash memory 11 is based on the file system of MS-DOS™, the flash memory 11 may pre-store, for example, a directory and an FAT (File Allocation Table). Prior to the reading of the user data, the computer 2 makes the CPU 121 read out the directory and FAT first and acquires them. Based on the acquired directory and FAT, the computer 2 specifies the page address from which data is to be read out and the logical block address to which the page belongs. In this case, for example, a predetermined logical block address may be assigned to the block in which the directory and FAT are stored.

When writing data into the flash memory 11, first, the computer 2 supplies a command instructing to write data into the flash memory 11, and the logical block address and page address where the data included in the file is to be written, to the controller 12.

In the case where the storage area of the flash memory 11 is based on the file system of MS-DOS and pre-stores a directory and an FAT, the computer 2 may operate as follows: First, the computer 2 acquires the directory and FAT from the memory unit 1. Next, based on them, the computer 2 specifies the page address and logical block address of a page in which no data is stored. Then, the computer 2 updates the directory and FAT to represent that data has been written in this logical block, and writes them back into the flash memory 11.

When a command instructing to write data and the logical block address and page address are supplied from the computer 2, the memory unit 1 first reads an old user data (FIG. 6, step S100).

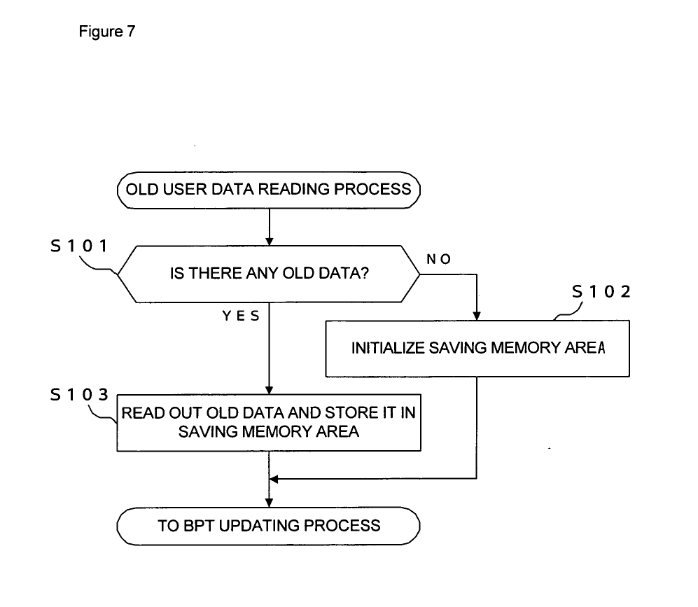

In reading the old user data shown in FIG. 7, the CPU 121 first searches the BPT stored in the RAM 123 using the logical block address supplied from the computer as the key. Then, the CPU 121 determines whether or not any physical block address associated with this logical block address has been searched out. This is how the CPU 121 determines whether there is any old data that is to be rewritten (FIG. 7, step S101).

In a case where no corresponding physical block address has been found, the CPU 121 determines that there is no old data. In this case, the CPU 121 erases the data stored in the saving memory area in the RAM 123. For example, the CPU 121 updates the values of all the bits of the data stored in the saving memory area to “1”. By this operation, the saving memory area is initialized (step S102). After this, the process flow goes to a BPT updating process (FIG. 6, step S200).

To the contrary, in a case where it is determined at step S101 that there is some old data, the CPU 121 reads out the old data stored in the block indicated by the physical block address found. Then, the CPU 121 stores the old data into the saving memory area (step S103). After this, the CPU 121 goes to the BPT updating process (step S200).

The CPU 121 treats the saving memory area initialized at step S102 the same as having had data saved therein at step S103 in the BPT updating process and succeeding processes.

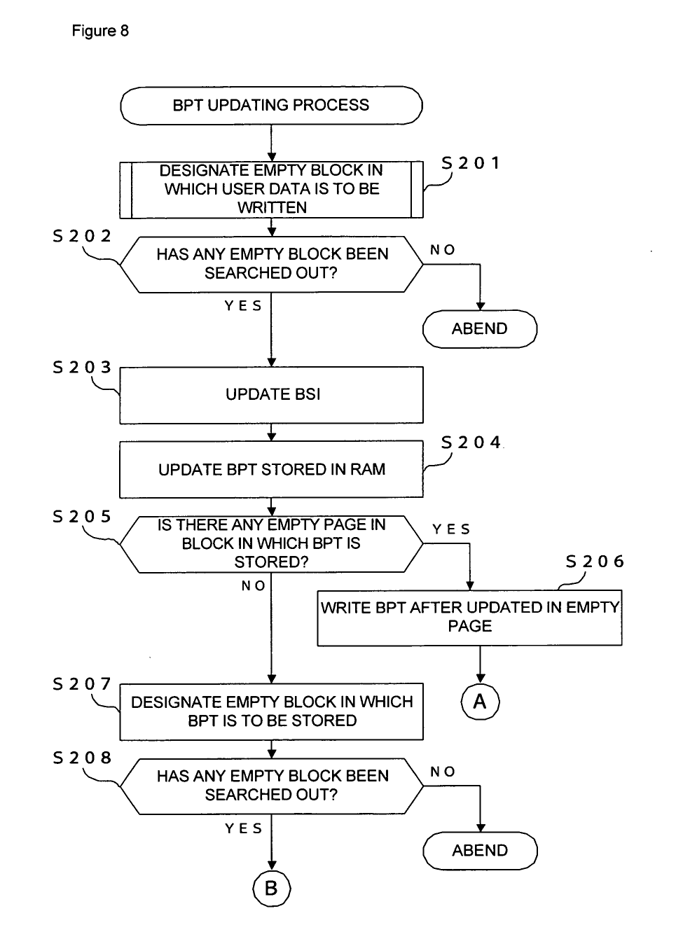

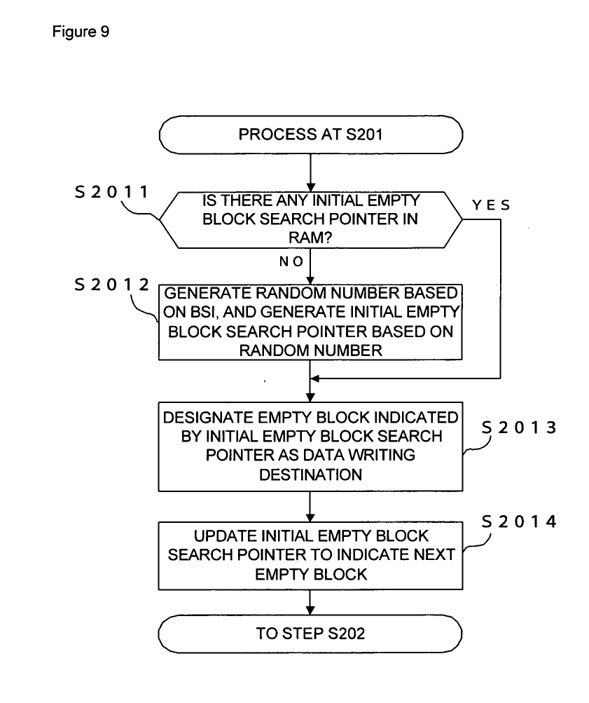

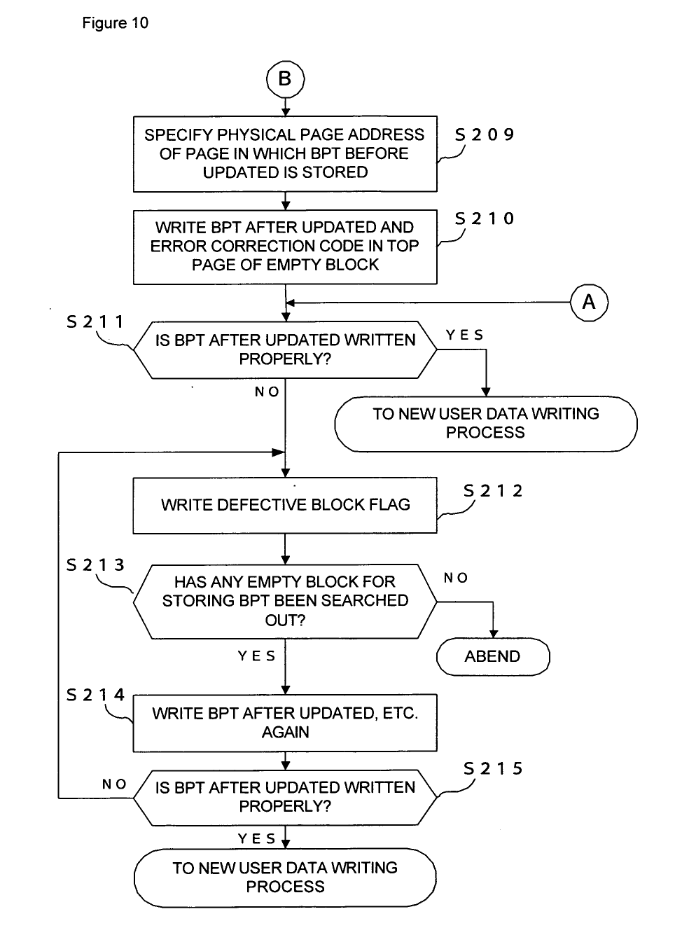

When updating BPT as shown in FIG. 8 and FIG. 10, the CPU 121 first designates the physical block address of one empty block in which user data is to be newly written (FIG. 8, step S201). The process at step S201 specifically comprises steps S2011 to S2014 shown in FIG. 9.

At step S201, the CPU 121 first determines whether or not the RAM 123 stores an initial empty-block-search pointer (FIG. 9, step S2011). In a case where there is an initial empty-block -search pointer stored, the CPU 121 advances the process flow to step S2013. In a case where no initial-empty-block search pointer is stored, the CPU 121 advances the process flow to step S2012.

At step S2012, the CPU 121 generates a random number based on the BSI currently stored in the RAM 123. An initial empty-block-search pointer indicating the physical block address of an empty block with this random number is then stored in the RAM 123. When the process at step S2012 is completed, the CPU 121 advances the process flow to step S2013.

At step S2012, the CPU 121 generates calculation data, which represents the exclusive OR of a portion of the data stored in the BSI, that occupies the head portion of the BSI over a predetermined length (for example, 8 bytes), and another portion of the stored data that succeeds this portion and has the same length. Then, the CPU 121 generates calculation data, which represents the exclusive OR of the calculation data generated most recently, and a portion of the stored data that has the predetermined length and appears at the head portion of the BSI data which has not yet been used for generating calculation data. The CPU 121 repeats this process until all the portions of the BSI have been used for generating calculation data. Then, according to a known method, the CPU 121 generates random number, which represents a natural pseudo random number whose maximum value is the total number of empty blocks currently registered in the BSI, using the calculation data generated last as a seed. Then, the CPU 121 designates the physical block address, among the physical block addresses of the empty blocks currently registered in the BSI, whose order is equal to the value of this random number, as an initial value. An initial empty-block-search pointer which indicates the value of the designated physical block address is stored in the RAM 123.

At step S2013, the CPU 121 designates the empty block indicated by the initial empty block search pointer, as the block to write the user data in. Then, the CPU 121 specifies an empty block whose physical block address is the earliest next to that of this empty block, by, for example, searching the BSI. Then, the CPU 121 updates the value of the initial empty-block-search pointer to indicate this specified empty block (step S2014). After this, the process flow is moved to step S202.

At step S2014, in a case where there is no empty block whose physical block address is the earliest next to that of the empty block designated at step S2013, the CPU 121 updates the initial empty block pointer to the empty block whose physical block address is the earliest of all the empty blocks.

At step S202, the CPU 121 determines whether or not an empty block has been designated properly at step S201 (step S202). In a case where an empty block has not been designated properly, the CPU 121 determines that there is no empty block and data cannot be written, and abends the data writing process.

To the contrary, in a case where the designation of an empty block has been performed properly, the CPU 121 updates the content of the BSI to represent that the designated empty block is no longer an empty block thereafter (step S203). In addition, the CPU 121 updates the BPT in the RAM 123 such that the physical block address of the designated empty block is associated with the current logical block address where the old data is stored (step S204).

Next, the CPU 121 determines whether or not there is still any empty page in which no BPT has been stored in the BPT storing block(step S205). When there is any such page, the CPU 121 writes the updated BPT in the RAM 123, to the empty page succeeding the page that the BPT before the update is stored. Then, the CPU 121 generates an error-correction code for the BPT after updated, writes this error-correction code in the redundant area of that page (step S206), and moves the process flow to step S211.

To the contrary, when there is no empty page at step S205, the CPU 121 performs substantially the same process as the process at step S201 described above. By performing this process, the CPU 121 designates the physical block address of one empty block to which the BPT is to be newly written (step S207). Then, the CPU 121 determines whether or not any empty block has been designated properly (step S208). In a case where it is determined that an empty block has been designated, the CPU 121 moves the process flow to step S209 in FIG. 10. To the contrary, in a case where it is determined that no empty block has been designated, the CPU 121 determines that there is no empty block and the BPT cannot be written, and abends the data writing process.

At step S209, the CPU 121 specifies the physical page address of the BPT before the update. Then, the CPU 121 writes the updated BPT in the RAM 123 in the top page of the empty block designated at step S207 (step S210). Further, at step S210, the CPU 121 generates an error-correction code of the updated BPT. This error-correction code is written in the redundant area of the page in which the updated BPT is written.

At step S211, the CPU 121 refers to the value in the internal register of the flash memory 11. By this reference, the CPU 121 determines whether or not the writing at step S210 has been performed properly. Then, in a case where it is determined that the writing has been performed properly, the CPU 121 moves on to a new user data writing process (FIG. 6, step S300).

To the contrary, if it is determined at step S211 that the writing has not been performed properly, the CPU 121 determines that the block in which data has not been written properly at step S210 or at later-described step S214 has become a postnatal defective block. Then, the CPU 121 writes a defective block flag in the redundant area of a page of that block (step S212).

Then, in order to retry the writing of the updated BPT, the CPU 121 performs substantially the same processes as steps S207 and S208 (step S213). If no empty block is searched out, the CPU 121 abends the data writing process. If any empty block is searched out, the CPU 121 performs substantially the same process as step S210 (step S214). As a result, writing of the updated BPT and an error-correction code is performed.

After the process of step S214, the CPU 121 refers to the value in the internal register of the flash memory 11, likewise at step S211. By this reference, it is determined whether or not the writing at step S214 has been performed properly (step S215). When it is determined that the writing has been performed properly, the CPU 121 terminates the BPT updating process and moves on to the new user data writing process (FIG. 6, step S300). In a case where it is determined that the writing has not be performed properly, the CPU 121 returns the process flow to step S212.

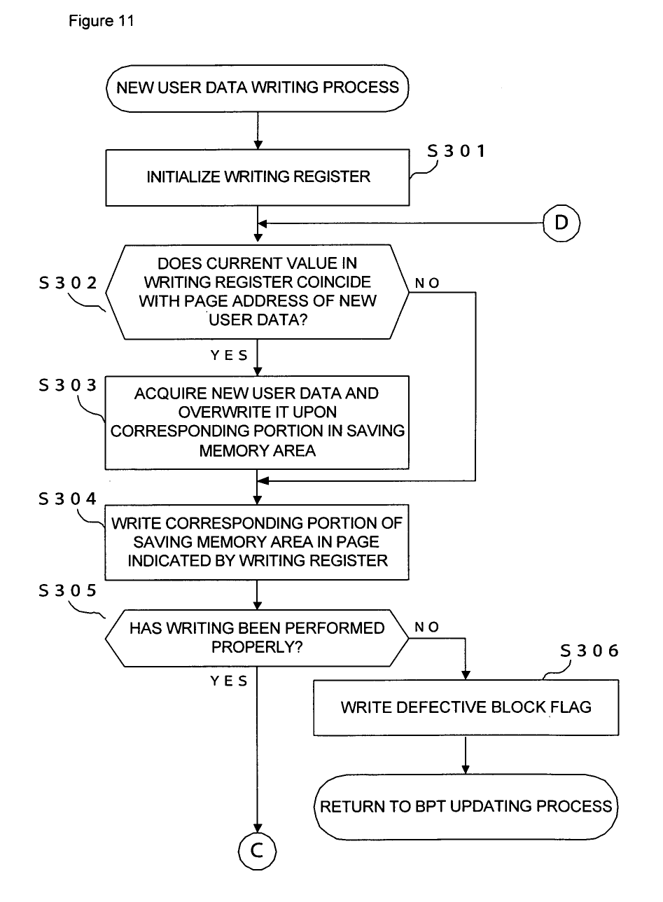

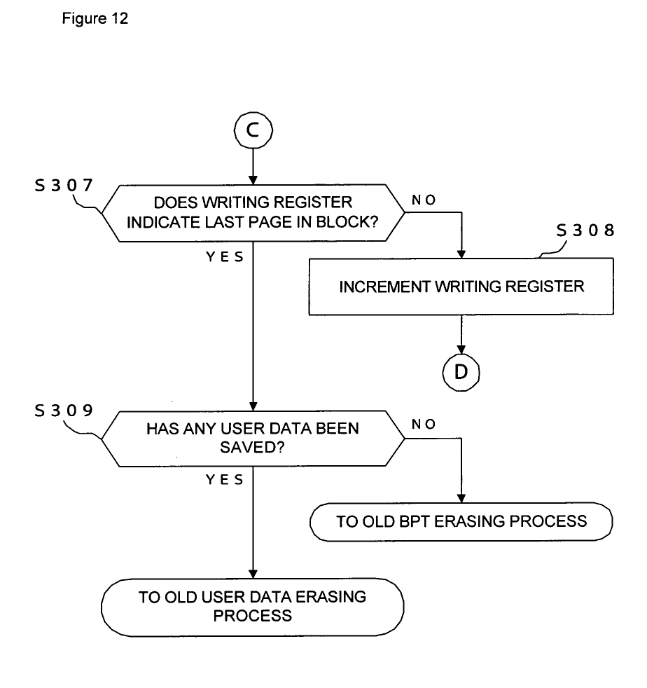

FIG.11 and 12 show the details of the new user data writing process. First, the CPU 121 declares its use of a register (writing register) in which a variable to indicate the page to write user data in is to be stored. Then, the CPU 121 initializes the writing register. That is, the CPU 121 sets the page address of the top page of the block, which has been searched out at step S201, in the writing register (FIG. 11, step S301).

Next, the CPU 121 determines whether or not the current value in the writing register coincides with the page address supplied from the computer 2 at step S201 (step S302). If they do not match, the CPU 121 moves the process flow to step S304.

To the contrary, when determined that the two addresses coincide with each other, the CPU 121 instructs the computer 2 to supply a portion of the new user data to be stored at the page address indicated by the writing register. The computer 2 supplies the corresponding data portion to the CPU 121 in accordance with this instruction.

Then, the CPU 121 overwrites a portion of the data from the computer 2. This portion is the part stored in the same page as indicated by the writing register among the data copied to the saving memory area at step S103 (i.e., the block from which the data has been read out at step S103) (step S303). Then, the process flow is moved to step S304.

At step S304, the CPU 121 reads out a portion of the data copied to the saving memory at step S103. This portion is the part stored in the same page as indicated by the writing register in the original block. Then, the CPU 121 writes the read-out data in a page of the copy destination block, where the page is specified by the physical block address searched out at step S201 and the page address stored in the writing register. Then, the process flow is moved to step S305. It should be noted that, at step S304, of the data to be written in the page, the data corresponding to the logical block address in the redundant area is changed to the logical block address of the copy destination block.

At step S305, the CPU 121 determines whether or not the data was written properly at step S304. This may be done by referring to the value in the internal register of the flash memory 11 after the data is written. When determined that the data has been written properly, the CPU 121 moves the process flow to step S307. When determined that the data has not been written properly, the CPU 121 moves the process flow to step S306.

At step S306, the CPU 121 determines the block, in which the data has not been written properly, as having become a postnatal defective block. The CPU 121 writes a defective block flag in the redundant area of a page of that block, and moves the process flow to the BPT updating process.

At step S307, the CPU 121 determines whether or not the page address indicated by the writing register is the last page of the block to which the data is now being written. If the page address does not indicate the last page, the CPU 121 increments the value in the writing register by 1 page (step S308). That is, the CPU 121 updates the value in the writing register to the next page. When step S308 is completed, the CPU 121 returns the process flow to step S302.

On the other hand, if determined at step S307 that the page address stored in the writing register indicates the last page of the block in which the data writing is now being performed, the CPU 121 moves the process flow to step S309.

At step S309, the CPU 121 determines whether or not there is any block from which old user data has been saved to the RAM 123 prior to writing the new user data. That is, the CPU 121 determines whether or not any physical block address has been searched out at step S101. In a case where there is no such block, the CPU 121 goes to an old BPT erasing process (FIG. 6, step S500).

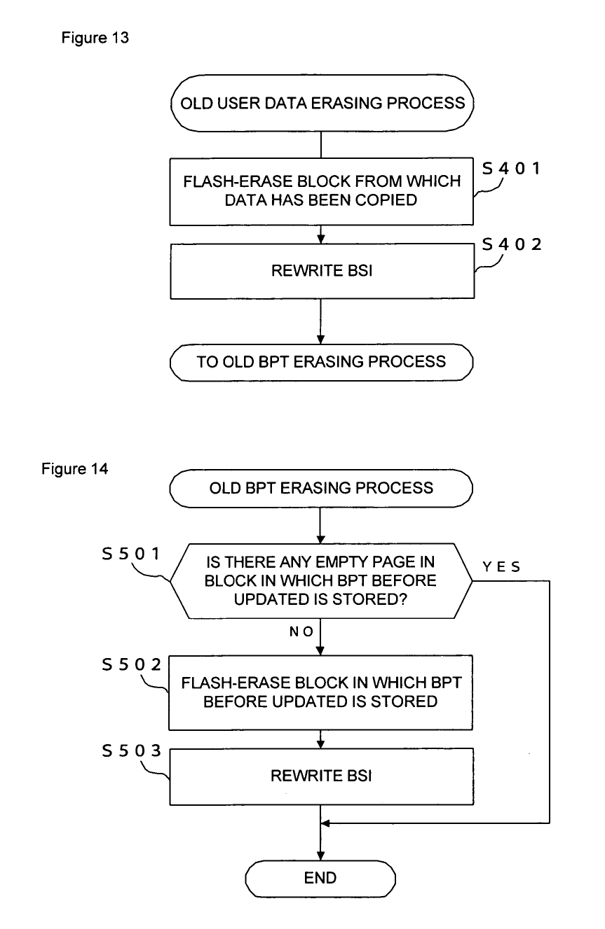

To the contrary, if there is a block from which data has been saved, the storage system performs an old user data erasing process which is specifically shown in FIG. 13 (FIG. 6, step S400). First, the CPU 121 flash-erases the data stored in the copy source block (i.e., the block indicated by the physical block address searched out at step S101)(FIG. 13, step S401). Then, the CPU 121 accesses the BSI, too. At this time, the CPU 121 rewrites the content of the BSI to represent that the block whose data has been erased at step S401 is an empty block (step S402). With this, the old user data erasing process is completed. Then, the CPU 121 moves on to the old BPT erasing process (FIG. 6, step S500).

FIG. 14 shows the details of the old BPT erasing process. First, the CPU 121 determines whether there was any empty page in the block that stores the BPT before the update (FIG. 14, step S501). If there is an empty page, the CPU 121 terminates the whole data writing process.

To the contrary, if there is no empty page, the CPU 121 flash-erases the block that stores the BPT before the update (step S502). Then, the CPU 121 also accesses the BSI, and rewrites the contents of the BSI to represent that the block whose data has been erased at step S502 is an empty block (step S503). As a result, the whole data writing process is completed.

In the present storage system explained above, spotting of the empty blocks in which the user data and the BPT are to be written is performed sequentially from the physical block address indicated by the initial empty-block-search pointer, as the start point. Meanwhile, the initial value of the initial empty-block-search pointer is determined according to the random number generated based on the BSI. The contents of the BSI is changed every time an empty block is to be newly used or a block being flash-erased. Accordingly, a the random number sequence generated based on the BSI will not have a certain pattern. Therefore, a situation that the blocks having the physical block addresses that coincide with the certain pattern of the random numbers are intensively flash-erased and data-written and thereby intensively deteriorated is prevented.

The structure of the present storage system is not limited to the one described above. For example, the method according to which the CPU 121 generates a random number based on the BSI at step S2012 is arbitrary.

For example, in generating calculation data representing the exclusive OR at step S2012, the CPU 121 may start from the data stored at a predetermined position of the BSI. Further, in generating calculation data representing the exclusive OR by using the calculation data generated most recently and a portion of the stored data in the BSI that has not yet been used for generating calculation data, the method to select a portion that has not yet been used for calculation data generation may also be arbitrary.

Further, a random number may be generated by, for example, using the entire BSI as one seed. A value obtained by substituting the entire BSI in a hash function may be used as a seed. Furthermore, a value obtained by subjecting the BSI to an arbitrary calculation may be used as a seed.

The data used by the CPU 121 at step S2012 for generating a random number need not be the BSI. Any other data that is changed or highly probably changed each time data is written may be used to generate a random number. Accordingly, the CPU 121 may use the BPT instead of the BSI for generating a random number. Further, in a case where the flash memory 11 stores an FAT, the FAT may be used instead of the BSI for generating a random number.

Instead of performing the processes of steps S2011 and S2012, the CPU 121 may generate a random number based on the BSI immediately after this BSI is generated through the process of step S004 of the initial process, and store, in the RAM 123, an initial empty-block-search pointer, which indicates the value of the physical block address of the empty block indicated by this random number.

Further, the number of blocks in the storage area of the flash memory 11, the number of pages per block, the storage capacity of each page, the storage capacity of the data area and redundant area are all arbitrary. The flash memory 11 needs not be constituted by an EEPROM, but may also be an arbitrary storage device readable and writable by a computer.

One embodiment of the present invention has been explained above. However, the storage device and memory managing device according to the present invention can be realized not only by a special system, but also by an ordinary computer system. For example, a storage system which performs the processes described above can be built by installing a program to perform the above-described operations by the controller 12 and the computer 2, onto a personal computer connected to the flash memory 11 from a medium such as a flexible disk or a CD-ROM which store this program.

Furthermore, for example, this program may be uploaded onto a bulletin board system (BBS) on a communication network and may be distributed through the communication network. Then, by activating this program and executing the program under the control of an OS in the same way as other application programs are executed, the above-described processes can be performed.

In a case where the OS shares a part of the processes or the OS constitutes part of one component of the present invention, a program from which such part is excluded may be stored in the recording medium. Also in this case, the program to realize each function or each step performed by the computer is stored in that recording medium.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2005-324585 filed on Nov. 9, 2005 and including specification, claims, drawings and summary. The disclosure of the above Japanese Patent Application is incorporated herein by reference in its entirety.

What is claimed is:

1. A storage device, comprising
a storage unit including a plurality of memory blocks, each of which has an assigned physical addresses, and which are for storing user data;
a pointer storage unit which stores a pointer indicating the physical address of one empty block in said memory blocks that are ready to store a user data;
a pointer initial value generating unit which generates an initial value of the pointer;
a writing unit which writes to-be-written user data in said empty block indicated by the pointer; and
a pointer updating unit which updates the pointer to indicate another empty block having a physical address next to the physical address of said empty block indicated by the pointer, in the case where said empty block indicated by the pointer is designated as a destination of the to-be-written data;
wherein said pointer initial value generating unit generates a random number based on predetermined data which will be changed each time user data is newly stored in any empty block, determines an initial value, based on the random number, of an address of empty blocks in which user data is to be written, and stores the pointer indicating this initial value in said pointer storage unit.

2. The storage device according to claim 1, further comprising
an empty block table storage unit which stores an empty block table for storing information to specify an empty block, among said memory blocks, that is in a user data storable state,
wherein said pointer initial value generating unit generates a random number based on a content of said empty block table, and determines an initial value for physical address of empty blocks in which user data is to be written based on the generated random number.

3. The storage device according to claim 2,
wherein said pointer initial value generating unit comprises:
a logical calculation unit which generates calculated data representing an exclusive OR of a portion of data stored in said empty block table, that occupies a predetermined position of said empty block table and has a predetermined length, and a portion of the stored data that succeeds said portion and has the predetermined length, and after this repeats a process of generating calculated data representing an exclusive OR of calculated data generated most recently and a portion of the stored data that has the predetermined length and appears next to data portions stored in said empty block table that have not yet been used for generating calculated data, until all portions of said empty block table have been used for generating calculated data;
a random number generating unit which generates random number data representing a natural pseudo random number, whose maximum value is a total number of empty blocks currently registered in said empty block table, and the random number data being generated by using calculated data generated last by said logical calculation unit as a seed; and
an initial value determining unit which determines a physical address, among the physical addresses of empty blocks currently registered in said empty block table, whose order is equal to a value of the random number data, as the initial value, and stores the pointer which indicates this initial value.

4. A memory managing device for storing user data in a memory including a plurality of memory blocks which are assigned physical addresses and which are for storing user data, said memory managing device comprising:
a pointer storage unit which stores a pointer indicating the physical address of one empty block, among said memory blocks, that is in a user data storable state;
a pointer initial value generating unit which generates an initial value of the pointer;
a writing unit which writes user data, which is an objective of writing, in said empty block indicated by the pointer; and
a pointer updating unit which updates the pointer to indicate another empty block having a physical address that appears next to the physical address of said empty block indicated by the pointer, in the case where said empty block indicated by the pointer is designated as a destination at which the user data as the objective of writing is to be written,
wherein said pointer initial value generating unit generates a random number based on predetermined data which will be changed each time user data is newly stored in any empty block, determines an initial value of empty blocks in which user data is to be written based on the generated random number, and stores the pointer indicating this initial value in said pointer storage unit.

5. The memory managing device according to claim 4, further comprising
an empty block table storage unit which stores an empty block table for storing information to specify an empty block, among said memory blocks, that is in a user data storable state,
wherein said pointer initial value generating unit generates a random number based on a content of said empty block table, and determines an initial value for physical address of empty blocks in which user data is to be written based on the generated random number.

6. The memory managing device according to claim 5,
wherein said pointer initial value generating unit comprises:
a logical calculation unit which generates calculated data representing an exclusive OR of a portion of data stored in said empty block table, that occupies a predetermined position of said empty block table and has a predetermined length, and a portion of the stored data that succeeds said portion and has the predetermined length, and after this repeats a process of generating calculated data representing an exclusive OR of calculation data generated most recently and a portion of the stored data that has the predetermined length and appears next to data portions stored in said empty block table that have not yet been used for generating calculation data, until all portions of said empty block table have been used for generating calculated data;
a random number generating unit which generates random number data representing a natural pseudo random number, whose maximum value is a total number of empty blocks currently registered in said empty block table, by using calculated data generated last by said logical calculation unit as a seed; and
an initial value determining unit which determines a physical address, among the physical addresses of empty blocks currently registered in said empty block table, whose order is equal to a value of the random number data, as the initial value, and stores the pointer indicating this initial value.

7. A memory managing method for storing user data in a memory including a plurality of memory blocks which are assigned physical addresses and or storing user data, said method comprising:
a pointer initial value generating step of generating an initial value of the pointer, in a case where it is determined that the pointer storage unit does not store the pointer;
a step of determining an empty block indicated by the pointer, as a destination at which user data, which is an objective of writing, is to be written; and
a pointer updating step of updating the pointer to indicate another empty block having a physical address that appears next to the physical address of said empty block indicated by the pointer, when said empty block indicated by the pointer is designated as a destination at which the user data as the objective of writing is to be written,
wherein at said pointer initial value generating step, a random number is generated based on predetermined data which will be changed each time user data is newly stored in any empty block, an initial value of empty blocks in which user data is to be written is determined based on the generated random number, and the pointer, which indicates this initial value, is stored in said pointer storage unit.

8. A memory managing method according to claim 7, further comprising
a determining step of determining whether or not a pointer storage unit stores the pointer indicating the physical address of one empty block, among the memory blocks, that is in a user data storable state, in the case where to-be-written user data is specified.

9. A recording medium storing a program for controlling a computer to function as a memory managing device for storing user data in a memory including a plurality of memory blocks which are assigned physical addresses and for storing user data, said memory managing device comprising:
a pointer storage unit which stores a pointer, which indicates the physical address of one empty block, among said memory blocks, that is in a user data storable state;
a pointer initial value generating unit which generates an initial value of the pointer;
a writing unit which writes user data, which is an objective of writing, in said empty block indicated by the pointer; and
a pointer updating unit which updates the pointer to indicate another empty block having a physical address that appears next to the physical address of said empty block indicated by the pointer, when said empty block indicated by the pointer is designated as a destination at which the user data as the objective of writing is to be written,
wherein said pointer initial value generating unit generates a random number based on predetermined data which will be changed each time user data is newly stored in any empty block, determines an initial value of empty blocks in which user data is to be written based on the generated random number, and stores the pointer, which indicates this initial value, in said pointer storage unit.
